(19) United States
(12) Patent Application Publication
(10) Pub. No.: US 2015/0095447 A1
(43) Pub. Date: Apr. 2, 2015

(54) SERVING METHOD OF CACHE SERVER, CACHE SERVER, AND SYSTEM

(71) Applicant: HUAWEI TECHNOLOGIES CO., LTD., Shenzhen (CN)

(72) Inventors: Wenxiao Yu, Nanjing (CN); Jinhui Zhang, Nanjing (CN); Youqing Yang, Nanjing (CN)

(73) Assignee: HUAWEI TECHNOLOGIES CO., LTD., Shenzhen (CN)

(21) Appl. No.: 14/564,703

(22) Filed: Dec. 9, 2014

Related U.S. Application Data
(63) Continuation of application No. PCT/CN2013/076680, filed on Jun. 4, 2013.

(30) Foreign Application Priority Data
Jun. 15, 2012 (CN) 201210199126.7

(51) Int. Cl. H04L 29/08

(52) U.S. Cl. CPC H04L 67/2857
USPC 709/214

(57) ABSTRACT

A serving method of a cache server relates to the field of communications, and can reduce bandwidth consumption of an upstream network and alleviate network pressure. The method include: receiving first request information sent by multiple user equipments, where the first request information indicates data separately required by the multiple user equipments and request points for the data separately required; if it is determined that same data is indicated in the first request information sent by at least two user equipments among the multiple user equipments and the same data has not been cached in the cache server, selecting one request point from request points falling within a preset window; and sending second request information to a source server, where the second request information indicates the uncached data and the selected request point.

### CROSS-REFERENCE TO RELATED APPLICATIONS

This application is a continuation of International Application No. PCT/CN2013/076680, filed on Jun. 4, 2013, which claims the priority to Chinese Patent Application No. 201210199126.7, filed on Jun. 15, 2012, both of which are hereby incorporated by reference in their entireties.

### TECHNICAL FIELD

The present invention relates to the field of communications, and in particular, to a serving method of a cache server, a cache server, and a system.

### BACKGROUND

In recent years, with the rapid development of Internet videos, the number of users dramatically grows. Network videos gradually become an important channel used by people to acquire digital content such as movies and news. Because a video is a comprehensive medium that integrates an image, sound, text, and the like, the rapid development of Internet videos causes explosive growth of the amount of data in a network, which brings heavy traffic pressure on the network, and push an operator to continuously expanding network bandwidth to ensure smooth deployment and operation of various services.

To alleviate network pressure, lower traffic costs, and provide better services for users, an operator usually deploys a cache server at a network edge (near a user side). The cache server can cache popular content and provide services for nearby users. If content requested by a user has been cached in a cache server, the content no longer needs to be acquired from a source server, and therefore traffic of an upstream network is reduced and network pressure is alleviated. If content requested by a user has not been cached in a cache server, the content still needs to be acquired from a source server, and as a result service traffic is still heavy, traffic occupied by an upstream network cannot be reduced, and network pressure cannot be alleviated.

### SUMMARY

According to an aspect, a serving method of a cache server includes:
receiving first request information sent by multiple user equipments, where the first request information indicates data separately required by the multiple user equipments and request points for the data separately required;
if it is determined that same data is indicated in the first request information sent by at least two user equipments among the multiple user equipments and the same data has not been cached in the cache server, selecting one request point from request points falling within a preset window; and
sending second request information to a source server, where the second request information indicates the uncached data and the selected request point.

Optionally, the preset window is a preset fixed window or a preset dynamically-changing window.

Optionally, the preset fixed window is a window with a fixed occupied time or a window with a fixed number of occupied bytes.

Optionally, the preset dynamically-changing window is a window with an occupied time dynamically changing according to a user status and an upstream network status, or is a window with occupied bytes dynamically changing according to an upstream network status and a user status.

Optionally, the falling within the preset window includes: a time difference between the different request points requesting the same uncached data being less than or equal to a time occupied by the preset window.

Optionally, the falling within the preset window includes: a byte difference between different data request points requesting the same uncached data being less than or equal to bytes occupied by the preset window.

Optionally, the selecting one request point from request points falling within the preset window includes: selecting, from the request points falling within the preset window, one request point closest to a start position of the preset window.

Optionally, after the sending second request information to a source server, the method further includes: receiving the uncached data that is sent by the source server and starts from a position corresponding to the request point; and according to the request points indicated in the received first request information sent by the multiple user equipments, separately sending the data from the position corresponding to the request points to the user equipments.

Optionally, the receiving the uncached data that is sent by the source server and starts from a position corresponding to the request point includes: receiving the uncached data that is sent by the source server from the request point and has not been received, and stopping receiving the uncached data that has been received.

Optionally, after the receiving the uncached data that is sent by the source server from the request point and has not been received, and stopping receiving the uncached data that has been received, the method further includes: merging the received uncached data; and caching the merged data.

Optionally, before the caching the merged data, the method further includes: if the merged uncached data is incomplete, sending third request information to the source server, where the third request information indicates the uncached data and a start point of the data; and receiving the data that is sent by the source server and is from the start point.

Optionally, after the selecting one request point from request points falling within the preset window, the method further includes: if the uncached data sent by the source server is received, acquiring a random access point included in the data, and updating the request point according to the random access point.

An aspect provides a cache server, which includes:
a first receiving unit, configured to receive first request information sent by multiple user equipments, where the first request information indicates data separately required by the multiple user equipments and request points for the data separately required;
a selecting unit, configured to: if it is determined that same data is indicated in the first request information that is sent by at least two user equipments among the multiple user equipments and is received by the first receiving unit and the same data has not been cached in the cache server, select one request point from request points falling within the preset window; and
a first sending unit, configured to send second request information to a source server, where the second request information indicates the uncached data and the request point that is selected by the selecting unit.

Optionally, the selecting unit is specifically configured to select, from the request points falling within the preset window, one request point closest to a start position of the preset window.

Optionally, the cache server further includes a second receiving unit and a second sending unit, where the second receiving unit is configured to receive the uncached data that is sent by the source server and starts from a position corresponding to the request point; and the second sending unit is configured to: according to the request points indicated in the first request information that is sent by the multiple user equipments and is received by the first receiving unit, separately send, from the position corresponding to the request point, the data received by the second receiving unit to the user equipments.

Optionally, the second receiving unit is specifically configured to: receive the uncached data that is sent by the source server from the request point and has not been received, and stop receiving the uncached data that has been received.

Optionally, the cache server further includes a merging unit and a cache unit, where the merging unit is configured to merge the uncached data received by the second receiving unit; and the cache unit is configured to cache the data merged by the merging unit.

Optionally, the cache server further includes a processing unit, where the processing unit is configured to: if the uncached data merged by the merging unit is incomplete, enable the first sending unit to send third request information to the source server, where the third request information indicates the uncached data and a start point of the data; and the second receiving unit is further configured to receive the data that is sent by the source server and is from the start point.

Optionally, the processing unit is further configured to: if the second receiving unit receives the uncached data sent by the source server, acquire a random access point included in the data, and update the request point according to the random access point.

Another aspect provides a system, including a source server and at least one of the foregoing cache server; where
the source server is configured to receive second request information sent by the cache server, where the second request information indicates uncached data in the cache server and a request point for the data; and send, starting from a position corresponding to the request point, the uncached data to the cache server.

In the serving method of a cache server, the cache server, and the system, the cache server receives first request information sent by multiple user equipments, where each piece of first request information indicates data separately required by the multiple user equipments and request points for the data separately required; if the cache server determines that same required data is indicated in the first request information that is received by the cache server and sent by at least two user equipments among the multiple user equipments and the same data has not been cached in the cache server, selects one request point from request points falling within the preset window; and sends second request information to a source server, where the second request information indicates the uncached data and the selected request point. In this way, the cache server can avoid, by using a preset window, repeated requests, from close request points, for same data; because request points within a same preset window have close positions, requests from the request points can be considered as a same request from one same request point; and therefore, one request point is selected from the preset window to send a request to the source server, so that bandwidth consumption of an upstream network of the cache server and the source server can be reduced, thereby reducing traffic of the upstream network and alleviating network pressure.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a serving method of a cache server according to an embodiment of the present invention;

FIG. 2 is a schematic flowchart of another serving method of a cache server according to an embodiment of the present invention;

FIG. 3 is a schematic diagram of data received by a cache server from a random access point according to an embodiment of the present invention;

FIG. 4 is a schematic structural diagram of a cache server according to an embodiment of the present invention;

FIG. 5 is a schematic structural diagram of a cache server according to an embodiment of the present invention;

FIG. 6 is a schematic structural diagram of yet another cache server according to an embodiment of the present invention; and

FIG. 7 is a schematic structural diagram of a system according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

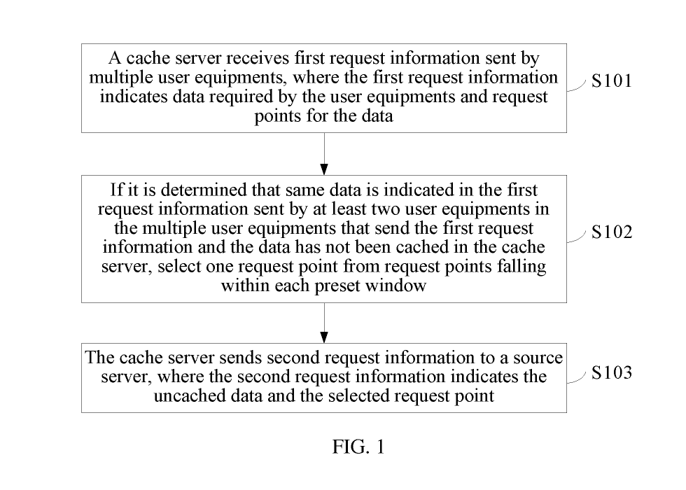

As shown in FIG. 1, a serving method of a cache server includes:

S101. A cache server receives first request information sent by multiple user equipments, where the first request information indicates data required by the user equipments and request points for the data.

If the cache server receives first request information sent by user equipments A, B, C, D, and E separately, piece of first request information indicates video data requested by each of the user equipments A, B, C, D, and E and a request point for the video data. That is, the first request information sent by the user equipment A indicates the video data requested by the user equipment A and a request point for the video data, the first request information sent by the user equipment B indicates the video data requested by the user equipment B and a request point for the video data, the first request information sent by the user equipment C indicates the video data requested by the user equipment C and a request point for the video data, the first request information sent by the user equipment D indicates the video data requested by the user equipment D and a request point for the video data, and the first request information sent by the user equipment E indicates the video data requested by the user equipment E and a request point for the video data. The request point represents a start position at which the user equipment needs to watch the video data. It is assumed that the user equipments A, B, and C request the same video data, for example, a movie M, and the user equipments A, B, and C have different request points for requesting the video data. The video data requested by the user equipments D and E are video data other than X, and the video data requested by the user equipments D and E may be same or different and corresponding request points may be same or different.

Further, if the user equipments A, B, and C do not request watching the video file M from a start point of the entire video file M, that is, do not watch the video file from the beginning, fields for indicating different request points of the video data requested by the user equipments A, B, and C exist in the request information sent by the user equipments A, B, and C. The request point may be a time point, at which the user equipment requests watching a video, relative to a start point of the entire video file, a specific byte position of a byte, at which the user equipment requests watching the video, in the entire video file, or the like. For example, in an HTTP (Hypertext Transport Protocol, Hypertext Transfer Protocol) request message, a parameter part of a start line uses start=x (or begin=x) to indicate a request point of this request, where x is the request point, which may indicates time, for example, x=32, indicating that the start watching time is the 32^{nd} second; and may also indicate the specific number of bytes, for example, 1204 indicates that the start watching position is the 1204^{th} byte.

S102. If it is determined that same data is indicated in the first request information sent by at least two user equipments among the multiple user equipments that send the first request information and the data has not been cached in the cache server, select one request point from request points falling within the preset window.

It should be noted that, if the data indicated in the first request information received by the cache server from the multiple user equipments has already been cached in the cache server, the data requested by the user equipments may be sent, starting from the request point requested by the user equipments, to each user equipment. If the data requested by a user equipment or some user equipments has not been cached in the cache server, the cache server requests the data that has not been cached in the cache server from a source server, and after receiving the data, then sends the data to the corresponding user equipment.

If the cache server receives requests for same uncached data from at least two user equipments among the multiple user equipments, and if request points of the received piece of video data are all separately requested and forwarded, heavy traffic of an upstream network needs to be occupied; and therefore, a preset window may be used to select same or different request points required by the at least two user equipments. For example, according to a preset window, one request point is selected from request points of the same data indicated in the first request information from the at least two user equipments to perform sending, thereby reducing repeated sending and reducing bandwidth consumption of the upstream network.

For example, the size of the preset window may be set according to time. For example, the preset window is 6 seconds, and in this case, the cache server receives first request information that requests a same file M uncached in the cache server and is from the user equipments A, B, and C, and the file M requested by the user equipments A, B, and C is denoted by “file-abc”. By using an HTTP request message as an example, it is assumed that the requests from the user equipments A, B, and C are respectively as follows:
User equipment A: “http:// xyz.com/file-abc?start=32& . . . ”
User equipment B: “http:// xyz.com/file-abc?start=58& . . . ”
User equipment C: “http:// xyz.com/file-abc?start=60& . . . ”

The unit of a start field is second, and certainly, another time unit, for example, minute, may also be used as the unit of the start field. In addition, a random time length may also be used as the unit of the start field, for example, every 5 seconds may be set as a timing unit of 1 start field. In this example, the unit of the start field is second.

It may be learned, from the request information of the user equipment A, the user equipment B, and the user equipment C, that a difference value between the request points requested by the user equipment A and the user equipment B is 26 (start_{A}−start_{B}=58−32=26 seconds) seconds. Because the size of the preset window is 6 s, the difference value between the request points requested by the user equipment A and the user equipment B is greater than the size of the preset window, the request point of the user equipment A and the request point of the user equipment B are not within one preset window. A difference value between the request points of the user equipment B and the user equipment C is 2 (start_{C}−start_{B}=60−58=2 seconds) seconds, the difference value between the request points of the user equipment B and the user equipment C is less than the size of the preset window. That is, the request points of the user equipment B and the user equipment C are within one preset window; and in this case, the cache server selects one request point from the request point of the user equipment B and the request point of the user equipment C which are within the preset window. Optionally, the cache server may ignore the request point of the user equipment C, and select the request point, which is closest to a start position of the preset window, of the user equipment B.

The preset window may be preset in a piece of data based on a time or byte position of the data. For example, in a 360-second video, one preset window is set for every 6 seconds starting from the start point, which is the 0^{th} second. The preset window may also be set according to the position of a request point in the received first request information. For example, in the foregoing example, the first preset window may start from the 32^{nd} second and has the size of 6 seconds, and therefore the difference between the request points of the user equipment A and the user equipment B is greater than 6 seconds, and the request points of the user equipment A and the user equipment B do not fall within one same preset window. The second preset window may start from the 58^{th} second and has the size of 6 seconds, and therefore the difference between the request points of the user equipment B and the user equipment C is less than 6 seconds and the request points of the user equipment B and the user equipment C fall within one same preset window. Further, one request point is selected from the request points that fall within one same preset window, and a request point, which is closest to the start position of the preset window, of the user equipment may be selected. For example, in a preset window, if the preset window starts from the 240^{th} second and ends at the 246^{th} second, the request point closest to the 240^{th} second is selected. For example, the preset window is determined according to a request point in the received first request information. If the preset window is determined according to the request point of the user equipment B, the request points of both the user equipment B and the user equipment C fall within the preset window. Because the preset window starts from the position of the request point of the user equipment B, the request point of the user equipment B is a request point closest to the preset window, and the request point of the user equipment B is selected. The request point closest to the start position of the preset window is selected, and all required data of required request points, that fall within the preset window, of other user equipments can be covered, so that the request point that is within the window and sent by the cache server to the source server includes all required content of the user equipments whose request points fall within the preset window.

It should be noted that, herein only the preset window to which the user equipment B and the user equipment C belong is used as an example for description. If the cache server also receives first request information from other user equipments at a same moment or within a predetermined time, and request points indicated in the first request information of other multiple user equipments are within a preset window, the same method may also be adopted to select one request point and ignore other request points. For example, if the user equipment D and the user equipment E request data N at the same time, and the data N has not been cached in the cache server, it needs to be determined according to the request point of the user equipment D, the request point of the user equipment E, and the preset window, whether to select one request point from the request point of the user equipment D and request point of the user equipment E and ignore the other request point. If a difference between the request points of the user equipment D and the user equipment E is less than the preset window, one request point is selected from the request point of the user equipment D and the request point of the user equipment E, and a request point, closest to the start position of the preset window, of the user equipment may be selected. The predetermined time may be an estimated time from when a user equipment sends a request to when a user sees a video, or a shorter time.

Further, the size of the current preset window may further be set according to bytes. For example, the preset window is 2048 bytes; in this case, if the request point requested by the user equipment A is the 1050^{th} byte, the request point requested by the user equipment B is the 1090^{th} byte, and the request point requested by the user equipment C is the 2000^{th} byte, a difference value between the request point of the user equipment A and the request point requested by the user equipment B is 40 bytes, a difference value between the request points requested by the user equipment A and the user equipment C is 50 bytes, and a difference value between the request points requested by the user equipment B and the user equipment C is 10 bytes; all these difference values are less than the preset window, which is 2048 bytes, and therefore the user equipments A, B, and C are within one same preset window, the request point, closest to the start position of the preset window, of the user equipment A may be selected, and the request points of the user equipment B and the user C are ignored. One request point is selected from the request points that fall within one same preset window, and a request point, which is closest to the start position of the preset window, of the user equipment may be selected.

It should be noted that, the size of the preset window may be fixed, or may also be dynamically adjusted. A factor that affects the size of the window may be a condition of the upstream network of the cache server, where the condition of the upstream network includes an upstream packet loss rate, a delay of the upstream network, and the like. In addition, the factor that affects the size of the window may further include a network condition of the user, for example, service bandwidth of the user, a network delay of the user, experience expectancy of the user. The relationship between the size of the preset window and each effect factors may be described qualitatively by using the following expression:

$${Size}_{win} ∝ \frac{{BW}_{user}}{{RTT}_{up} \cdot {PLR}_{up} \cdot {RTT}_{user} \cdot {E}_{user}}$$

where Size_{win} is the size of the preset window, BWᵤₛₑᵣ is the service bandwidth of the user equipment, RTTᵤₛₑᵣ is the delay of the user, RTTup is the delay of the upstream network, PLRup is the packet loss rate of the upstream network, and Eᵤₛₑᵣ is experience expectancy of the user. It may be learned, from the foregoing formula, that: when the condition of the upstream network is poorer, that is, the upstream packet loss rate is higher and the delay is larger, the preset window is smaller; when the condition of the user network is poorer, that is, in a case in which the service bandwidth of the user is fixed, and when the delay is larger, the preset window is smaller; when the experience expectancy of the user is higher, the preset window is smaller; and the like.

The size of the preset window may be set to be dynamically changeable according to the network condition, or may also be set to a fixed value obtained optimally by performing experiments multiple times.

S103. The cache server sends second request information to a source server, where the second request information indicates the uncached data and the selected request point.

Exemplarily, the cache server sends the second request information to the source server, where the second request information indicates the selected request point. For example, if the cache server selects request points of the user equipment A and the user equipment B after receiving requests of the user equipments A, B, and C for one same file, which is denoted by “file-abc” and uncached in the cache server, the cache server sends two pieces of second request information to the source server, where one piece of second request information indicates the file “file-abc” and the request point of the user equipment A, and the other piece of second request information indicates the file “file-abc” and the request point of the user equipment B.

In this way, the cache server may send, according to positions corresponding to the request points requested by the user equipments, data such as video data and audio data sent by the source server to the user equipments separately within the same preset window, so that while bandwidth consumption of the upstream network is reduced, watching demands of users are met.

In the foregoing serving method of a cache server, when the cache server receives, at the same time or within a predetermined time, first request information sent by multiple user equipments separately, each piece of first request information indicates required data of one user equipment among the multiple user equipments and a request point for the data; if it is determined that same data is requested in the received first request information sent by at least two user equipments in the multiple user equipments and the same data has not been cached in the cache server, selects one request point from request points, which fall within the preset window, of the at least two user equipments; and sends second request information to a source server, where the second request information indicates the data and the selected request point. In this way, the cache server can avoid, by using a preset window, repeated requests, from close request points, for same data; because request points within one same preset window have close positions, requests from the request points can be considered as a same request from one same request point; and therefore, one request point is selected from the preset window to send a request to the source server, so that bandwidth consumption of an upstream network of the cache server and the source server may be reduced, thereby reducing traffic of the upstream network and alleviating network pressure.

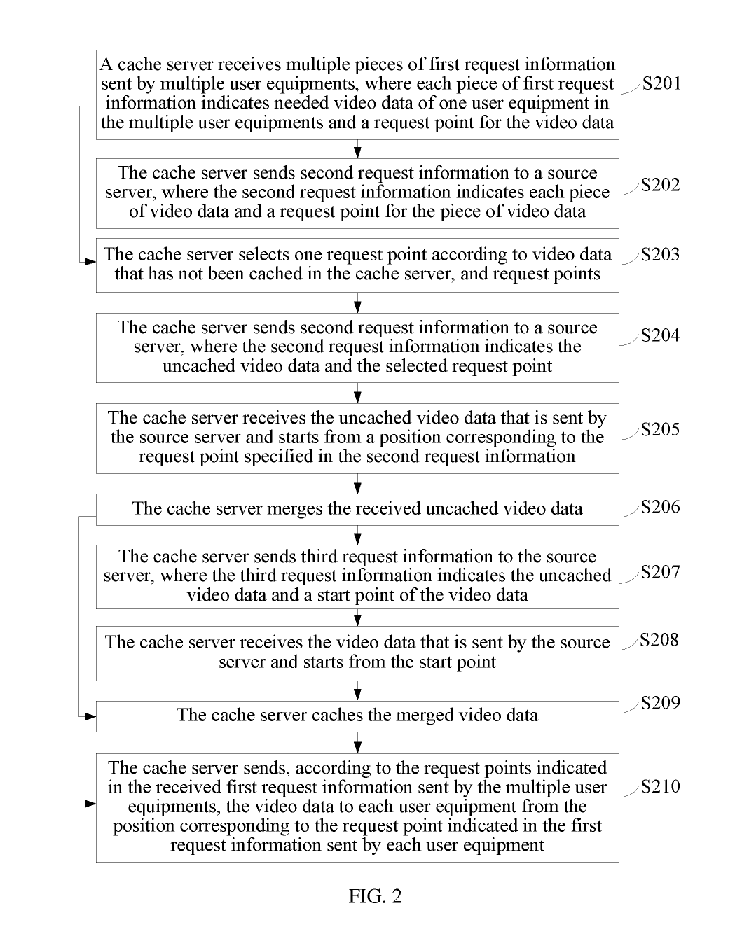

An example in which a cache server is a Cache server and data is video data is used for description; and however, this example does not pose any limitation. As shown in FIG. 2, another serving method of a cache server includes:

S201. The cache server receives multiple pieces of first request information sent by multiple user equipments separately, where each piece of first request information indicates required video data of one user equipment among the multiple user equipments and a request point for the video data.

It should be noted that, if the video data indicated in the first request information received by the cache server is video data that has been cached in the cache server, the cache server sends separately information about the corresponding video data to the user equipments that send the request. If the video data indicated in at least two pieces of first request information in the received multiple pieces of first request information is video data uncached in the cache server, and the uncached video data may be the same video data or may be different video data, or also may include both same video data and different video data.

If the at least two pieces of data that has not been cached include both same video data and different video data, the cache server may select, one piece by one piece, the same video data uncached in the cache server and perform processing according to a request point in corresponding first request information, and then select a next same piece of video data for processing after processing on one same piece of video data is completed; the cache server may also select, at the same time, multiple groups of video data that are not cached in the cache server to separately perform processing, where in the multiple groups of video data that are not locally cached in the cache server, and in each group, the pieces of video data uncached in the cache server are same, and the request points may be same or different.

Exemplarily, different uncached video data may be requests of multiple users for multiple pieces of video data. For example, a user equipment A, a user equipment B, and a user equipment C request a first movie, a user equipment D, a user equipment E, and a user equipment F request a second movie, a user equipment G requests a third movie, and a user equipment H requests a fourth movie. In this case, the cache server may send, to a source server, request information of the user equipment G for the third movie and the first request information of the user equipment H for the fourth movie. For multiple user equipments, for example, for the requests of the user equipment A, the user equipment B, and the user equipment C for the first movie and the requests of the user equipment D, the user equipment E, and the user equipment F for the second movie, after a request point is selected in S203, second request information that indicates the selected request point needs to be sent to the source server.

If the uncached video data is different video data, perform S202; if the uncached video data is same video data, perform S203.

S202. The cache server sends second request information to a source server, where the second request information indicates each piece of video data and a request point for the piece of video data.

It should be noted that, if different video data is requested in the first request information that is received by the cache server and separately sent by the multiple user equipments, and none of these pieces of video data has been cached in the cache server, no request point needs to be selected, and each piece of video data and second request information of a request point for the video data may be sent to the source server.

S203. The cache server selects one request point according to video data that has not been cached in the cache server, and request points.

It should be noted that, the preset window may be set according to time, for example, set to 6 seconds, or may also be measured by using the number of bytes, for example, set to 1 megabyte, or may also be set by using both of the two standards. An initial value may be set for the preset window. For example, the preset window is by default 6 seconds, 1M bytes, or the like. The methods for determining whether multiple request points requesting same data are within one preset window and selecting one request point from one preset window have been described in detail in the foregoing embodiment, and are not elaborated herein again.

It should be noted that if the required video data of the user equipment has not been cached in the cache server, forwarding to the source server is performed regardless of whether the required video data is same or whether the request points are same, high bandwidth consumption is caused to the upstream network; therefore, a preset window may be used to select one request point located within the preset window, where the request points located within the preset window may be multiple request points requesting same data, multiple request points requesting different data, or both multiple request points requesting same data and multiple request points requesting different data.

It should be noted that, before the cache server receives video data indicated in the second request information, the request point is a request point indicated in the first request information sent by the user equipment. When receiving the video data, the cache server acquires a random access point from the video data, and then may update the position of the indicated request point according to the random access point.

Generally, after being compressed and encoded, the video data is encapsulated based on a format and is then transmitted over a network. Common encapsulation formats of Internet videos include mp4, flv, f4v, and the like. The mp4, flv, f4v, and the like are usually referred to as containers. A container may summarize all information such as an encoding manner of audio and a video, a resolution of an image, duration of a video, and a position of a random access point in the video encoding data encapsulated in the container, so as to support operations such as dragging, replay, and fast forwarding during playing. The summarized information is usually placed at a start part of an entire video file, and the information is contained in both a complete video and a partial video clip; and a video cannot be played by a player without summarized information.

As long as a small part of video data is received, the cache server can acquire information about a random access point. For example, a user equipment requests the video data at a previous moment, the cache server only receives a small part of video data, and the video data has not been received completely and cached. In this case, the cache server has obtained the information about the random access point of the piece of video data, and the cache server may first adjust a request point requested by the user equipment according to the position of the random access point, and then perform selection on the adjusted request point in the preset window.

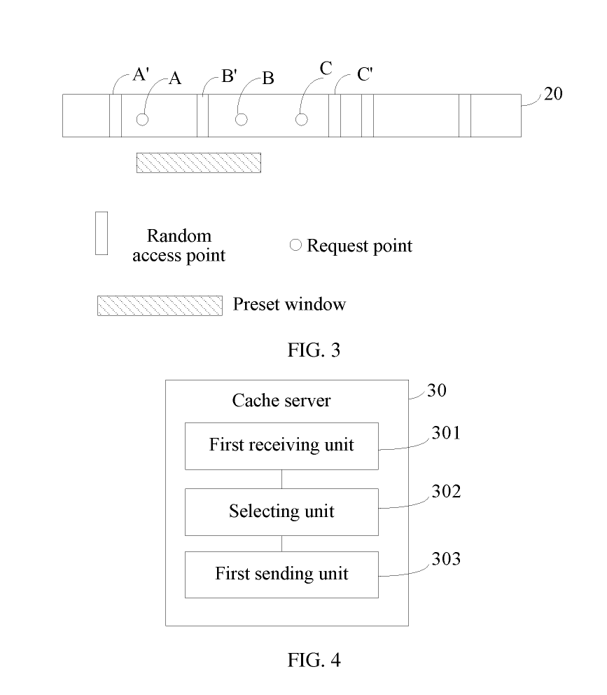

Exemplarily, as shown in FIG. 3, positions of random access points of video data 20 are denoted by A′, B′, and C′ separately, and 3 request points of a user equipment A, a user equipment B, and a user equipment C for the file at a moment are denoted by a request point A, a request point B, and a request point C, respectively. It is assumed that time points corresponding to the 3 request points of the user equipment A, the user equipment B, and the user equipment C for the file are the 42^{nd} second, the 46^{th} second, and the 50^{th} second, respectively, and the size of this preset window is 6 seconds; time points corresponding to the random access points A′, B′, and C′ are the 41.333^{th} second, the 45.583^{th} second, and the 51.583^{th} second, respectively. Consequently, before an adjustment, because a difference value between the request point of the user equipment A and the request point of the user equipment B is less than the size of the preset window, the request points are within a same window, and because a difference value between the request point of the user equipment A and the request point of the user equipment C is greater than the window, the request point of the user equipment A and the request point of the user equipment B are within one preset window, and the request point of the user equipment C is within another preset window; and finally, the 3 pieces of request information are located within two different windows. After selection, the cache server chooses to send, to the source server, two requests that indicates required data of the user equipment A and required data of the user equipment C.

By using the positions of the random access points, it may be found that the request point B and the request point C are in one same GOP (Group of Pictures, group of pictures). A GOP is video data that is between two adjacent random access points, and contains the former random access point but does not contain the latter random access point. Actually, although the cache server requests, from the source server, data at different position points in one same GOP, the source server usually starts to deliver data from the random access point B′ of the GOP; in this way, after receiving the data, the user equipment B and the user equipment C can start to play from B′ right away. It should be noted that the random access point is a point where the video data can be played immediately. Although a video watching device can place a slider at any position, the video data may not be played immediately at any position, and a video always starts to be played at a random access point near a request point specified by the slider. Therefore, the request points of the foregoing user equipment B and user equipment C are within one GOP, and the request points may be taken as one request point, that is, as long as the cache server sends, to the source server, one piece of request information at a position where the request point is B′, the requests of the user equipment B and the user equipment C for the video data can be accomplished. Similarly, the position of the request point A may be adjusted to a position where the request point is A′. In this way, the three request points A, B, and C are adjusted to become two request points at positions where the start points are A′ and B′.

It should be noted that, some server may also deliver data starting from a next GOP of a request point. In this embodiment, only an example in which data starts to be delivered from a previous GOP is used for description, which does not pose any limitation.

Next, the cache server performs selection according to whether an adjusted request is within a preset window. Because a difference value between the random access point A′ and the random access point B′ is 4.25 seconds and is less than the size of the preset window, which is 6 seconds, the random access point A′ and the random access point B′ are located within a same preset window. In this case, the cache server only sends one piece of second request information to the source server. Optionally, the request information of the request point A closest to the start position of the preset window may be forwarded to the source server, and the specific position of the request point may be the request point A indicated in the first request information of the user equipment A, or may also be the request point A′ obtained after the request point A indicated in the first request information of the user equipment A is adjusted. In this way, upstream bandwidth occupation is reduced, and meanwhile performance overheads caused by that the cache server may need to merge multiple video clips are also reduced.

It should be noted that after the cache server acquires the information about the random access point of the video data requested by the user equipment, for subsequent processing on the request of the user equipment, in a case in which the requested video is still uncached, the cache server can first adjust the request point of the user according to the position of the random access point, and then perform selection on the adjusted request point according to the preset window; and the request point of the user may also be first selected according to the preset window, the selected request point is then adjusted according to the position of the random access point, and finally selection is performed on the adjusted request point according to the preset window.

Further, sometimes the positions of random access points acquired by the cache server from a video header are not the positions of the random access points in an entire video file, and instead are the positions of the random access points in this video clip. In this case, the cache server may perform conversion according to request points in this clip and video data information in a container header to obtain the positions of the random access points in the entire video file. In this way, a subsequent request can still be processed based on this embodiment.

S204. The cache server sends second request information to a source server, where the second request information indicates the uncached video data and the selected request point.

It should be noted that multiple pieces of second request information may be sent by the cache server to the source server. For example, a request point selected from the preset window corresponds to one piece of second request information, and the cache server may send the second request information indicating these selected request points to the source server separately, so that source server sends, according to the positions corresponding to these request points, video data corresponding to the request points to the cache server.

S205. The cache server receives the uncached video data that is sent by the source server and starts from a position corresponding to the request point indicated in the second request information.

Exemplarily, if the request points indicated in the second request information sent by the cache server to the source server are the 130^{th} second, the 330^{th} second, and the 5690^{th} second, the source server also sends the video data to the cache server from positions corresponding to the 130^{th} second, the 330^{th} second, and the 5690^{th} second separately. It should be noted that the cache server can receive the video data starting from the three request points at the same time, and when the cache server receives the video data sent starting from the 130^{th} second to the 330^{th} second, the content starting from the 330^{th} second has been partially received, so that the cache server no longer repeatedly receives the content that has been received. After the cache server has completely received the data corresponding to the 130^{th} second to the data corresponding to the 330^{th} second, the cache server actively disconnects from the source server to terminate repeated reception of the data after the position corresponding to the 330^{th} second.

S206. The cache server merges the received uncached video data.

It should be noted that because the cache server stops receiving uncached video data that has been received, that is, the cache server does not receive the video data repeatedly, the cache server needs to merge the separately received clips of the video data into one complete piece of video data or video clip data.

After merging the video data, the cache server may perform S210. In addition, if a complete video is obtained after the video data is merged, performs S209, and if the video obtained after the video data is merged is incomplete, performs S207.

S207. The cache server sends third request information to the source server, where the third request information indicates the uncached video data and a start point of the uncached video data.

Exemplarily, if the cache server only receives and merges the video data from the 300^{th} second to the end, the cache server sends the third request information to the source server, where the third request information indicates the video data and the start point. The start point is the position of the 0^{th} second when the video data starts, so that the source server sends the video data to the cache server from the start point, where the start point may be considered as a request point at a special position, that is, the request point at the beginning position of the required data of the user equipment is the start point.

S208. The cache server receives the video data that is sent by the source server and starts from the start point.

It should be noted that after receiving the video data that is sent by the source server and starts from the start point, the cache server can merge, by using the received piece of video data starting from the start point, the received and incompletely merged video data and the piece of video data, so as to obtain a complete piece of video data.

S209. The cache server caches the merged video data.

S210. The cache server sends, according to the request points indicated in the received first request information sent by the multiple user equipments, the video data to each user equipment from the position corresponding to the request point indicated in the first request information sent by each user equipment.

Exemplarily, the cache server sends video data starting from a request point A of a user equipment A to the user equipment A, sends video data starting from a request point B of a user equipment B to the user equipment B, and sends video data starting from a request point C of a user equipment C to the user equipment C. Further, video data may also be separately sent to the user equipments from adjusted random access points.

In the serving method of a cache server provided in the embodiment of the present invention, the cache server receives first request information sent by multiple user equipments, where each piece of first request information indicates data required by the user equipments and request points for the data required; if it is determined that same required data is indicated in the received first request information sent by the user equipments and has not been cached in the cache server, selects one request point from request points falling within the preset window; and sends second request information to a source server, where the second request information indicates the data and the selected request point. In this way, the cache server can avoid, by using a preset window, repeated requests, from close request points, for same data; because request points within one same preset window have close positions, requests from the request points can be considered as a same request from one same request point; and therefore, one request point is selected from the preset window to send a request to the source server, so that bandwidth consumption of an upstream network of the cache server and the source server may be reduced, thereby reducing traffic of the upstream network and alleviating network pressure.

As shown in FIG. 4, a cache server 30 includes a first receiving unit 301, a selecting unit 302, and a first sending unit 303.

The first receiving unit 301 is configured to receive first request information sent by multiple user equipments, where the first request information indicates data required by each user equipment and a request point for the data required by each user equipment.

The selecting unit 302 is configured to: if it is determined that same data is indicated in the first request information that is sent by at least two user equipments among the multiple user equipments and is received by the first receiving unit 301 and the same data has not been cached in the cache server, select one request point from request points falling within the preset window.

Exemplarily, the selecting unit 302 selects, from multiple same request points, multiple different request points, or both multiple different request points and same request points that fall within the preset window, one request point closest to a start position of the preset window.

The first sending unit 303 is configured to send second request information to a source server, where the second request information indicates the uncached data and the request point that is selected by the selecting unit 302.

Further, the first sending unit 303 is further configured to: if request information of at least one user equipment indicates one same piece of uncached data and different request points of the uncached data and the request points are within different preset windows, send the second request information to the source server, where the second request information indicates each piece of uncached data and a request point for the data.

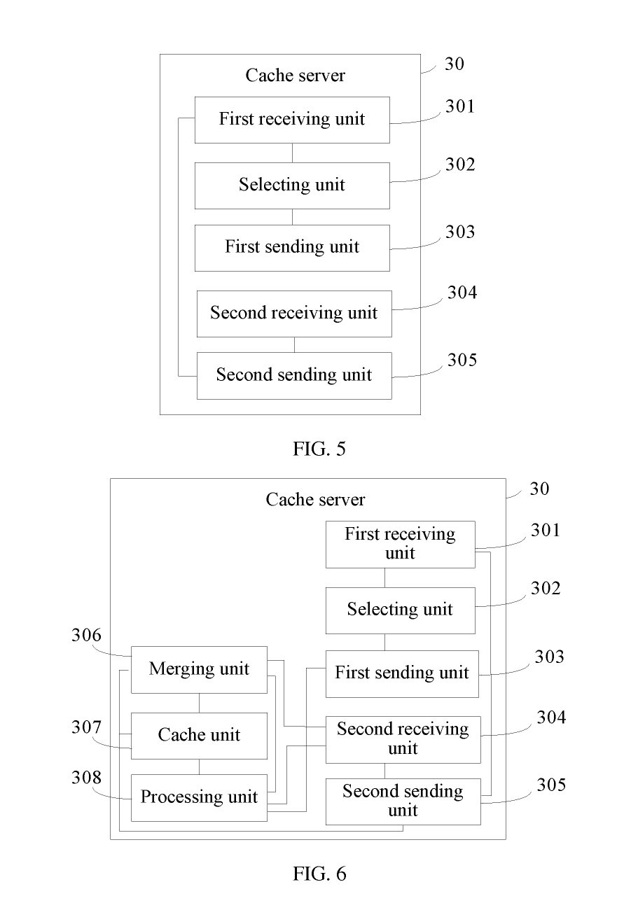

Further, as shown in FIG. 5, a cache server 30 further includes a second receiving unit 304 and a second sending unit 305.

The second receiving unit 304 is configured to receive the uncached data that is sent by a source server 40 and starts from a position corresponding to the request point.

Further, the second receiving unit 304 receives the uncached data that is sent by the source server 40 from positions corresponding to different request points and has not been received, and stops receiving the uncached data that has been received, that is, does not receive the uncached data repeatedly.

The second sending unit 305 is configured to separately send, according to the positions corresponding to the request points indicated in the first request information that is received by the first receiving unit 301 and sent by the multiple user equipments, from the positions corresponding to the request points, the data received by the second receiving unit 304 to the user equipment.

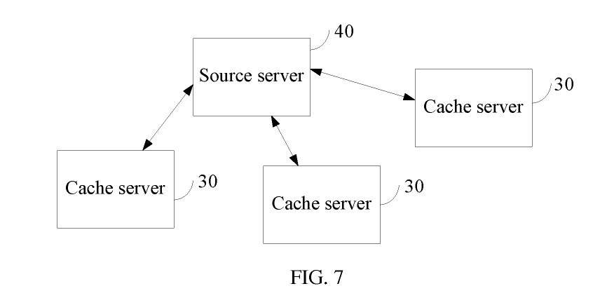

Further, as shown in FIG. 6, a cache server 30 further includes a merging unit 306, a cache unit 307, and a processing unit 308.

The merging unit 306 is configured to merge the uncached data received by the second receiving unit 304.

It should be noted that before the cache unit 307 caches the uncached data, the processing unit 308 is configured to: if the uncached data merged by the merging unit 306 is incomplete, enable the first sending unit 303 to send third request information to the source server 40, where the third request information indicates the uncached data and a start point of the data. The second receiving unit 304 is further configured to receive data that is sent by the source server 40 and starts from the start point, so that the merging unit 306 merges the data received by the second receiving unit 304 and the previously merged incomplete data.

The cache unit 307 is configured to cache the data merged by the merging unit 306.

Further, the processing unit 308 may be further configured to: if the second receiving unit 304 receives the uncached data sent by the source server 40, acquire a random access point included in the data, and update the request point according to the random access point.

The foregoing cache server 30 corresponds to the foregoing method embodiment, and may be used in the steps in the foregoing method embodiment. For the application of the cache server 30 in the specific step, reference may be made to the foregoing method embodiment, and details are not described herein again.

In the cache server 30 provided in the embodiment of the present invention, the cache server 30 receives first request information sent by at least two user equipments, where each piece of first request information indicates data required by a user equipment and a request point for the data; if it is determined that same data is required by the user equipments in the received and has not been cached in the cache server, selects one request point from request points falling within the preset window; and sends second request information to a source server, where the second request information indicates the data and the selected request point. In this way, the cache server 30 can avoid, by using a preset window, repeated requests, from close request points, for same data; because request points within one same preset window have close positions, requests from the request points can be considered as a same request from one same request point; and therefore, one request point is selected from the preset window to send a request to the source server, so that bandwidth consumption of an upstream network of the cache server 30 and the source server may be reduced, thereby reducing traffic of the upstream network and alleviating network pressure.

As shown in FIG. 7, a system provided in an embodiment of the present invention includes one or more cache servers 30 and a source server 40.

The cache server 30 may be at least one of the cache servers 30 in FIG. 4 to FIG. 6.

The source server 40 is configured to receive a second request sent by the cache server 30, where the second request information indicates data that has not been cached in the cache server and a request point for the data, and send the uncached data to the cache server 30 starting from a position corresponding to the request point.

It should be noted that the cache server 30 and the source server 40 correspond to the foregoing method embodiment, and may be used in the steps in the foregoing method embodiment. For the application of the cache server 30 and the source server 40 in each specific step, reference may be made to the foregoing method embodiment, and the specific structure of the cache server 30 is the same as that of the cache server provided in the foregoing embodiment and is not described in details herein again.

In the system provided in the embodiment of the present invention, the cache server 30 receives first request information sent by at least two user equipments, where each piece of first request information indicates data required by a user equipment, and a request point for the data; if it is determined that same data is required by the user equipments in the received and has not been cached in the cache server, selects one request point from request points falling within the preset window; and sends second request information to a source server 40, where the second request information indicates the data and the selected request point. In this way, the cache server 30 can avoid, by using a preset window, repeated requests, from close request points, for same data;

because request points within one same preset window have close positions, requests from the request points can be considered as a same request from one same request point; therefore, one request point is selected from the preset window to send a request to the source server 40, so that bandwidth consumption of an upstream network of the cache server 30 and the source server 40 may be reduced, thereby reducing traffic of the upstream network and alleviating network pressure.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A serving method of a cache server, comprising:
receiving first request information sent by multiple user equipments, wherein the first request information indicates data separately required by the multiple user equipments and request points for the data separately required;
if it is determined that same data is indicated in the first request information sent by at least two user equipments among the multiple user equipments and the same data has not been cached in the cache server, selecting one request point from request points falling within a preset window; and
sending second request information to a source server, wherein the second request information indicates the uncached data and the selected request point.

2. The serving method according to claim 1, wherein the preset window is a preset fixed window or a preset dynamically-changing window.

3. The serving method according to claim 2, wherein the preset fixed window is a window with a fixed occupied time or with a fixed number of occupied bytes.

4. The serving method according to claim 2, wherein the preset dynamically-changing window is a window with an occupied time dynamically changing according to a user status and an upstream network status, or is a window with occupied bytes dynamically changing according to an upstream network status and a user status.

5. The serving method according to claim 1, wherein the falling within the preset window comprises:
a time difference between different request points requesting same uncached data being less than or equal to a time occupied by the preset window.

6. The serving method according to claim 1, wherein the falling within the preset window comprises:
a byte difference between different data request points requesting same uncached data being less than or equal to bytes occupied by the preset window.

7. The serving method according to claim 1, wherein the selecting one request point from request points falling within the preset window comprises:
selecting, from the request points falling within the preset window, one request point closest to a start position of the preset window.

8. The serving method according to claim 1, after the sending second request information to a source server, further comprising:
receiving the uncached data that is sent by the source server and starts from a position corresponding to the request point; and
according to the request points indicated in the received first request information sent by the multiple user equipments, separately sending the data from the position corresponding to the request points to the user equipments.

9. The serving method according to claim 8, the receiving the uncached data that is sent by the source server and starts from a position corresponding to the request point comprising:
receiving the uncached data that is sent by the source server from the request point and has not been received, and stopping receiving the uncached data that has been received.

10. The serving method according to claim 9, after the receiving the uncached data that is sent by the source server from the request point and has not been received, and stopping receiving the uncached data that has been received, further comprising:
merging the received uncached data; and
caching the merged data.

11. The serving method according to claim 10, before the caching the merged data, further comprising:
if the merged uncached data is incomplete, sending third request information to the source server, wherein the third request information indicates the uncached data and a start point of the data; and
receiving the data that is sent by the source server and is from the start point.

12. The serving method according to claim 1, after the selecting one request point from request points falling within the preset window, further comprising:
if the uncached data sent by the source server is received, acquiring a random access point comprised in the data, and updating the request point according to the random access point.

13. A cache server, comprising:
a first receiving unit, configured to receive first request information sent by multiple user equipments, wherein the first request information indicates data separately required by the multiple user equipments and request points for the data separately required;
a selecting unit, configured to: if it is determined that same data is indicated in the first request information that is sent by at least two user equipments among the multiple user equipments and is received by the first receiving unit and the same data has not been cached in the cache server, select one request point from request points falling within a preset window; and
a first sending unit, configured to send second request information to a source server, wherein the second request information indicates the uncached data and the request point that is selected by the selecting unit.

14. The cache server according to claim 13, wherein
the selecting unit is specifically configured to select, from the request points falling within the preset window, one request point closest to a start position of the preset window.

15. The cache server according to claim 13, further comprising a second receiving unit and a second sending unit, wherein:
the second receiving unit is configured to receive the uncached data that is sent by the source server and starts from a position corresponding to the request point; and
the second sending unit is configured to: according to the request points indicated in the first request information that is sent by the multiple user equipments and is received by the first receiving unit, separately send, from the position corresponding to the request point, the data received by the second receiving unit to the user equipments.

16. The cache server according to claim 15, wherein
the second receiving unit is specifically configured to receive the uncached data that is sent by the source server from the request point and has not been received, and stop receiving the uncached data that has been received.

17. The cache server according to claim 16, further comprising a merging unit and a cache unit, wherein:
the merging unit is configured to merge the uncached data received by the second receiving unit; and
the cache unit is configured to cache the data merged by the merging unit.

18. The cache server according to claim 17, further comprising a processing unit, wherein:
the processing unit is configured to: if the uncached data merged by the merging unit is incomplete, enable the first sending unit to send third request information to the source server, wherein the third request information indicates the uncached data and a start point of the data; and
the second receiving unit is further configured to receive the data that is sent by the source server and is from the start point.

19. The cache server according to claim 13, wherein
the processing unit is further configured to: if the second receiving unit receives the uncached data sent by the source server, acquire a random access point comprised in the data, and update the request point according to the random access point.

20. A system, comprising a source server and at least one cache server, wherein:
the cache server is the cache server according to claim 13; and
the source server is configured to receive a second request sent by the cache server, wherein the second request information indicates data that is indicated in first request information received by the cache server and has not been cached in the cache server, and a request point for the data; and send, starting from a position corresponding to the request point, the uncached data to the cache server.
